(19) United States
(12) Patent Application Publication
(10) Pub. No.: US 2018/0055086 A1
(43) Pub. Date: Mar. 1, 2018

(54) Food Extruder and Method of Using the Same

(71) Applicant: Post Consumer Brands, LLC, Lakeville, MN (US)

(72) Inventors: Kevin Cizio, Lakeville, MN (US); Alan Erickson, Lakeville, MN (US)

(21) Appl. No.: 15/250,018

(22) Filed: Aug. 29, 2016

(51) Int. Cl. A23P 30/20; A23L 7/143

(52) U.S. Cl. CPC A23P 30/20; A23V 2002/00; A23L 7/143

(57) ABSTRACT

An extruder has an auger unit having an extruder screw. The extruder also has a food product inlet passageway and a food product die outlet. The food product inlet passageway is configured to receive food product extruded via the extruder screw. The food product die outlet is configured to expel food product from the extruder as an extrudate. The extruder further has at least first and second food passageways that operatively and in parallel connect the inlet passageway to the die outlet. The first and second food product passageways are configured such that food product passing through the first food passageway will travel from the inlet passageway to the die outlet more quickly than food product passing through the second food passageway will travel from the inlet passageway to the die outlet as additional food product is forced into the inlet passageway by the extruder screw.

### CROSS-REFERENCE TO RELATED APPLICATIONS

Not Applicable.

### STATEMENT REGARDING FEDERALLY SPONSORED RESEARCH OR DEVELOPMENT

Not Applicable.

### APPENDIX

Not Applicable.

### BACKGROUND OF THE INVENTION

### Field of the Invention

This invention relates generally to the extrusion of food products, such as ready-to-eat cereal. More particularly, the present invention pertains to an extruder for and method of blending two or more distinct compositions of food together prior to extruding such composition from an extrusion die.

### General Background

Extruders are used for various purposes, including for extruding food products in a continuous manner or as discrete parcels. In some circumstances, it is desirous to at least partially blend product of different compositions. For example, it may be desirous to blend food product of different color composition to create multi-colored food extrudate. A prime example of this is when extruding colored cereal pieces. Such blending can be achieved by extruding food product of different composition from two or more separate auger units into the same extrusion die to thereby mix said product prior to expelling the product from the die. Doing so however adds to the complexity, cost, and maintenance requirements of the extruder.

### SUMMARY OF THE INVENTION

The present invention allows for product of different compositions extruded sequentially from a single auger unit to be blended in an extruder prior to being discharged or expelled from the extruder.

In one aspect of the invention, an extruder for mixing food product being extruded from the extruder comprises an auger unit having an extruder screw. The extruder also comprises a food product inlet passageway and a food product die outlet. The food product inlet passageway is configured to receive food product extruded via the extruder screw. The food product die outlet is configured to expel food product from the extruder as an extrudate. The extruder further comprises at least first and second food passageways that operatively and in parallel connect the inlet passageway to the die outlet. The first and second food product passageways are configured such that food product passing through the first food passageway will travel from the inlet passageway to the die outlet more quickly than food product passing through the second food passageway will travel from the inlet passageway to the die outlet as food product is forced into the inlet passageway by the extruder screw.

Another aspect of the invention pertains to an adaptor unit for mixing food product being extruded from a food extruder. The adaptor unit is configured and adapted to operatively attach to an auger unit of an extruder to a die plate unit that comprises a die outlet for expelling food product as an extrudate. The adaptor unit comprises at least first and second food passageways that are each configured and adapted to operatively and in parallel connect a food product outlet of the auger unit to the die outlet of the die plate unit. The first and second food product passageways are configured such that food product passing into the adaptor unit from the food product outlet of the auger unit will travel through the adapter unit to the food product inlet of the die plate unit more quickly than food product passing through the second food passageway will travel from the food product outlet of the auger unit to the food product inlet of the die plate.

Yet another aspect of the invention pertains to a method of extruding food product. The method comprises forcing an amount of food product into a food product inlet passageway via an extruder screw. The method also comprises channeling a first portion of the amount of food product from the food product inlet passageway into a first food passageway while simultaneously channeling a second portion of the amount of food product from the food product inlet passageway into a second food passageway by forcing additional food product into the food product inlet passageway. The first food passageway has a downstream outlet that discharges into a third food passageway. Likewise, the second food passageway has a downstream outlet that discharges into the third food passageway. The first and second food passageways are operatively parallel and the method further comprises thereafter forcing additional food product out of the auger unit and into the first and second food passageways in manner causing the first and second portions of the first amount of food product to enter the third passageway, yet with the first portion of the amount of food product entering the third food passageway prior to the second portion of the amount of food product.

Still further, another aspect of the invention pertains to a method of extruding food product comprising channeling food product from an auger unit of an extruder to a die outlet of the extruder via at least two operatively parallel food passageways. As this occurs, food product passing through one of the two food passageways takes longer to travel from the auger unit to the outlet than food product passing through the other of the two food passageways.

Further features and advantages of the present invention, as well as the operation of the invention, are described in detail below with reference to the accompanying drawings.

### BRIEF DESCRIPTION OF THE DRAWINGS

FIG. 1 schematically depicts a prior art extruder.

FIG. 2 schematically depicts an embodiment of an extruder in accordance with the invention.

FIG. 3 schematically depicts a portion of one outlet passageway of the extruder depicted in FIG. 2.

FIG. 4 schematically depicts the flow of product through the portion of the outlet passageway depicted in FIG. 3.

FIG. 5 is a perspective view of an embodiment of an adaptor unit for making and/or practicing the invention and shows the upstream end and sides of the adaptor unit.

FIG. 6 is a perspective view of the adaptor unit shown in FIG. 5 and shows the downstream end and sides of the adaptor unit.

FIG. 7 is an upstream end view of the adaptor unit shown in FIGS. 5 and 6.

FIG. 8 is a cross-sectional view of the adaptor unit shown in FIGS. 5-7, taken about the line 8-8 shown in FIG. 7.

FIG. 9 is an assembly view of the adaptor unit shown in FIGS. 5-8.

Reference numerals in the written specification and in the drawing figures indicate corresponding items.

### DETAILED DESCRIPTION

FIG. 1 schematically depicts a prior art extruder (20) of the type used to extrude food products. The extruder (20) comprises an auger unit (22), a transition plate (24), and a die plate (26). The auger unit (22) comprises a extrusion screw (28) that is revolvable within a housing (30). The auger unit (22) is configured to force extrusion product toward and through the transition plate (24), and die plate (26). The transition plate (24) merely separates the product stream into multiple product streams that each lead to separate outlets. The die plate (26) comprises the outlets (32) for emitting the extrudate.

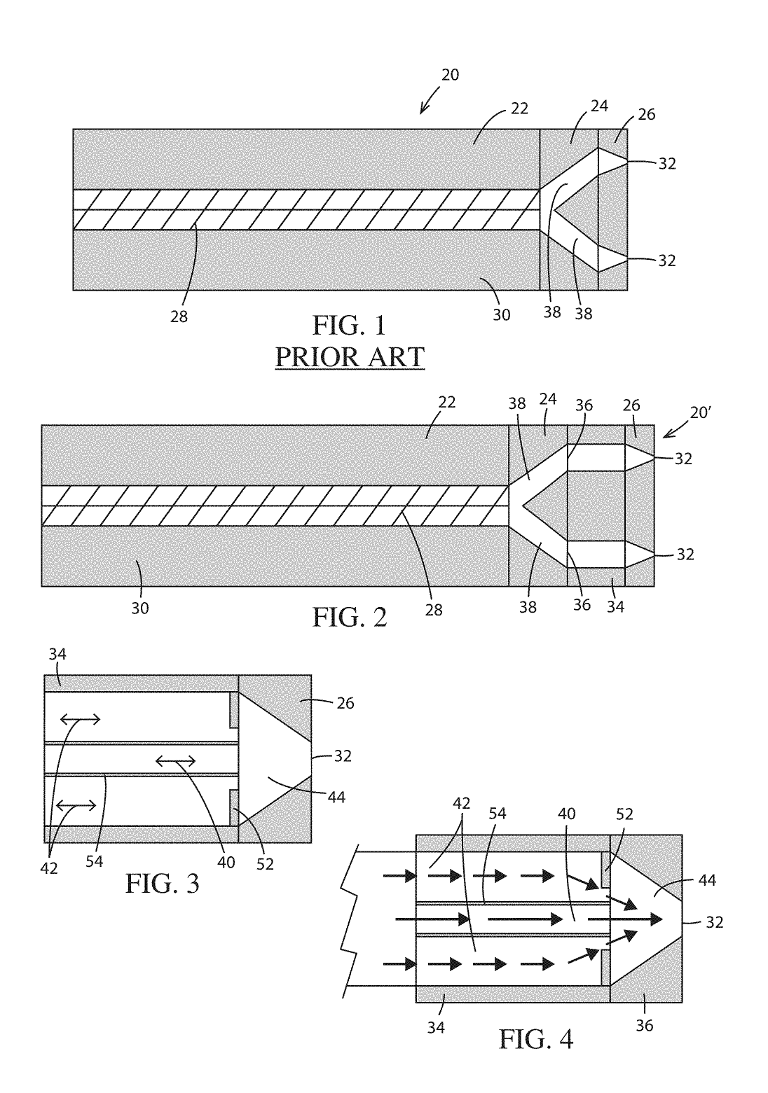

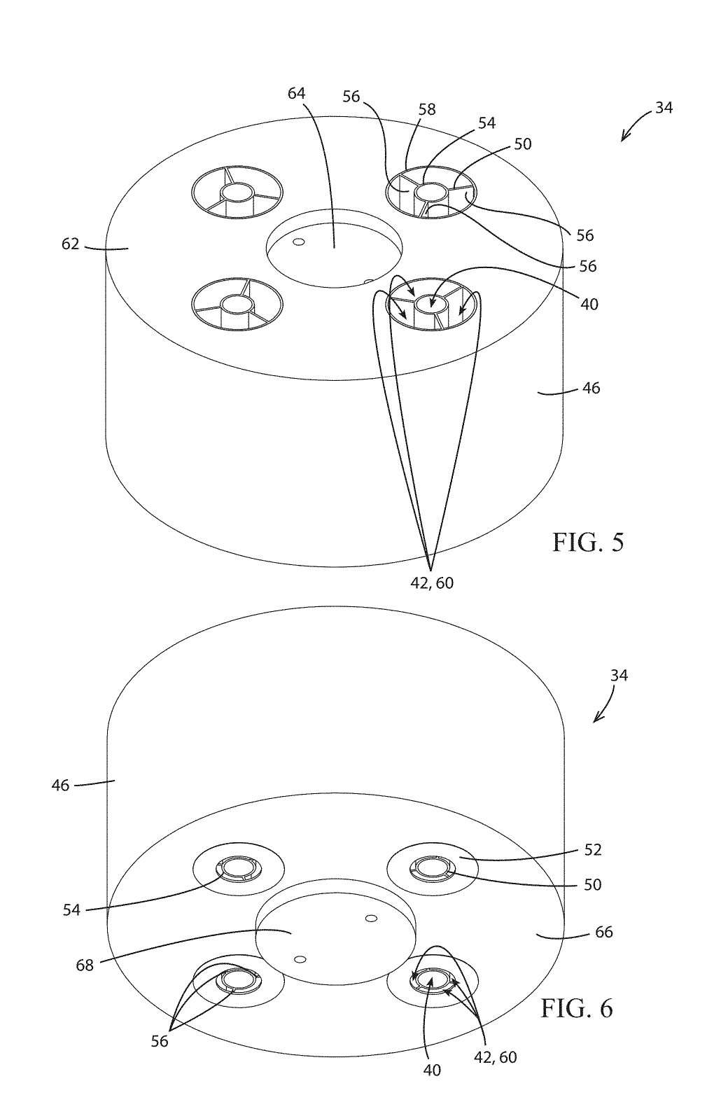

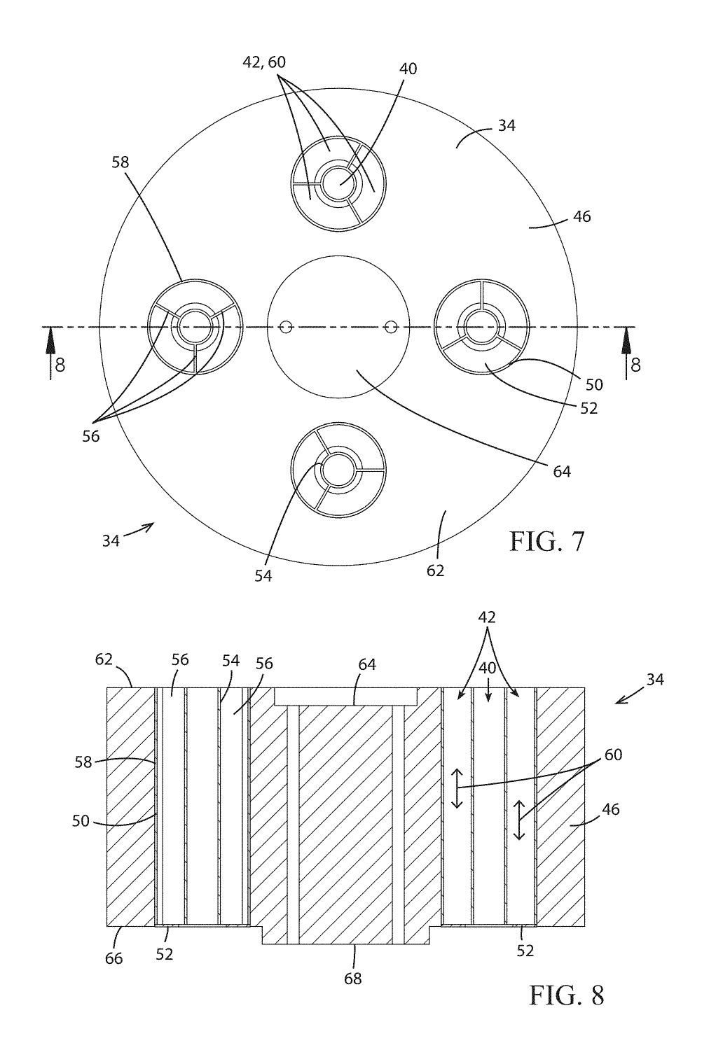

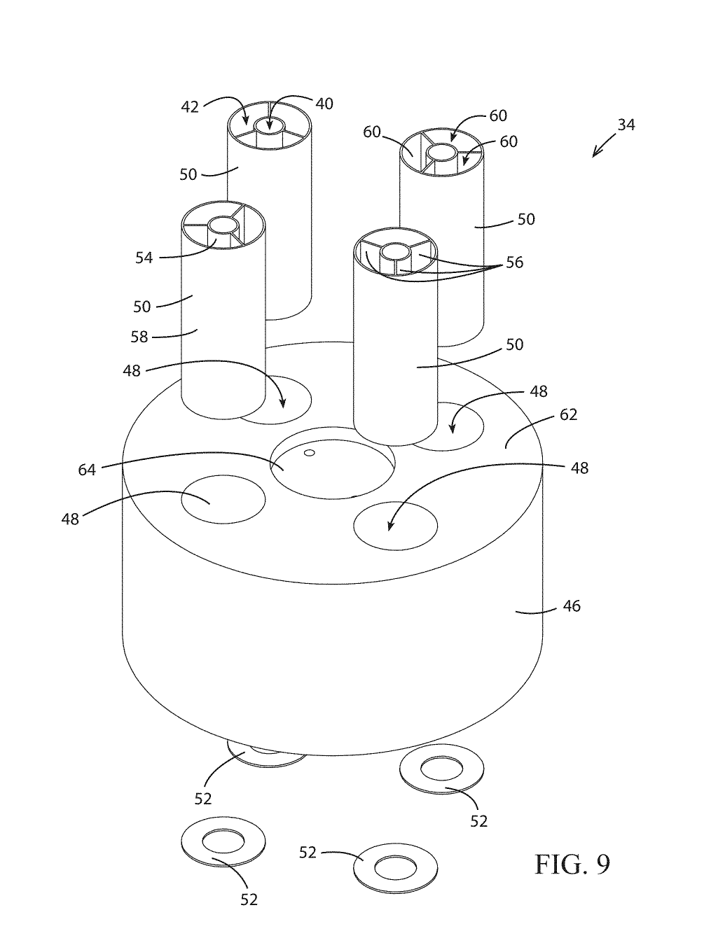

The present invention is preferably configured to modify an existing extruder such as the extruder described above. However, the present invention could also be incorporated into new extruders as an integral portion thereof. In its preferred embodiment, the invention comprises a residence time splitter plate (34) that is configured and adapted to be sandwiched between the transition plate (24) and the die plate (26), as is shown in FIG. 2. The residence time splitter plate (34) is configured to receive extrusion product from the outlets (36) of the passageways (38) of the transition plate (24). The residence time splitter plate (34) then channels the extrusion product from each of the outlets (36) of the transition plate (24) into two operatively parallel and separate passageways. A first one (40) of the two passageways is configured to allow the food product to pass through the residence time splitter plate (34) more quickly than through the second passageway (42). Hence, there is two different residence times for food product to pass through the residence time splitter plate (34). The time it takes extrusion product to pass through the first passageway (40) is less than the time it takes extrusion product to pass through the second passageway (42). From the first and second extrusion product passageways (40, 42) of the residence time splitter plate (34), the food product travels into a nozzle (44) of the die plate (26), where the separate flows of extrusion product then at least partially mix and are ultimately expelled from the extruder (20′) out of the outlets (32) of the die plate (26). With the differences in residence time of food product passing through the residence time splitter plate (34), different compositions of food product can be mixed together even though they are expelled from the auger unit (22) sequentially. Preferably, the residence time differential created by the residence time splitter plate (34) is equal to the time differential between different compositions of food product moving through the auger unit (22). As a result and for example, if the compositions of food product are different in that they differ in color, the product of the first color will be at least partially mixed with the product of the second color upon leaving the first and second passageways (40, 42) of the residence time splitter plate (34).

In its preferred embodiment, the residence time splitter plate (34) comprises a cylindrical main body (46) in which a through-hole (48) is drilled or otherwise formed for each outlet (36) of the transition plate (24). A removable divider tube (50) is positioned in each of the through-holes (48). A removable restriction member (52) is also placed in each though-hole (48) immediately downstream of the divider tube (50). Each divider tube (50) preferably comprises an inner tube (54) that bounds and defines the first passageway (40), a plurality of ribs (56), and a concentric outer tube (58), with the second passageway (42) being radially between the inner and outer tubes and encircling the inner tube. The inner tube (54) is held in position relative to the outer tube (58) via the ribs (56), which also subdivide the second passageway into a plurality of sub-passageways (60). The leading side (62) of the residence time splitter plate (34) preferably comprises an attachment fitting (64) that matches whatever attachment fitting is provided on the die plate (26). Similarly, the trailing side (66) of the residence time splitter plate (34) preferably comprises an attachment fitting (68) that matches whatever corresponding attachment fitting is provided on the transition plate (24). Thus, in its preferred embodiment, adding the residence time splitter plate (34) to an existing extruder requires no appreciable modification of the extruder. The restriction members (52) are preferably merely washers, with each having an outer diameter equal to the outer diameter of the divider tubes (50) an inner diameter slightly greater than the outer diameter of the inner tube (54) of each divider tube. Thus, the restriction members (52) partially obstruct only the second passageways (42) of the residence time splitter plate (34). The partial obstruction nonetheless limits flow rate of food product passing through the second passageways (42) of the residence time splitter plate (34). The inner diameter of the restriction members (52) is preferably configured to allow the same volumetric flow rate of food product to exit the second passageways (42) of the restriction members (52) as exits from the first passageways (40). Thus, food product streams exiting the first and second passageways (40, 42) mix or partially mix in equal amounts. However, the second passageway (42) preferably has a larger cross-sectional area than does the first passageway (40). As such, food product takes longer to pass through the second passageway (42) than it does through the first passageway (40). As a result, when the auger unit (22) sequentially expels food product of different compositions, such compositions can mix after they pass through the divider tubes (50) of the residence time splitter plate (34). This allows, for example, different colors or different flavors of food product to be blended into extrudate being expelled from the extruder (20′), without also requiring multiple extrusion screws. By altering the dimension the inner diameter of the restrictors (52) the residence time shift of food product passing through the divider tubes (50) can be altered to achieve various different effects.

It should also be appreciated that the removable nature of the divider tubes (50) and of the restriction members (52) facilitates periodic cleaning of the residence time splitter plate (34)

In view of the foregoing, it should be appreciated that the invention has several advantages over the prior art.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

It should also be understood that when introducing elements of the present invention in the claims or in the above description of exemplary embodiments of the invention, the terms “comprising,” “including,” and “having” are intended to be open-ended and mean that there may be additional elements other than the listed elements. Additionally, the term “portion” should be construed as meaning some or all of the item or element that it qualifies. Moreover, use of identifiers such as first, second, and third should not be construed in a manner imposing any relative position or time sequence between limitations. Still further, the order in which the steps of any method claim that follows are presented should not be construed in a manner limiting the order in which such steps must be performed, unless such an order is inherent.

What is claimed is:

1. An extruder for mixing food product being extruded from the extruder, the extruder comprising:
an auger unit having an extruder screw;
a food product inlet passageway configured to receive food product extruded via the extruder screw;
a food product die outlet configured and adapted to expel food product from the extruder as an extrudate;
at least first and second food passageways that operatively and in parallel connect the inlet passageway to the die outlet, the first and second food product passageways being configured such that food product passing through the first food passageway will travel from the inlet passageway to the die outlet more quickly than food product passing through the second food passageway will travel from the inlet passageway to the die outlet as additional food product is forced into the inlet passageway by the extruder screw.

2. An extruder in accordance with claim 1 wherein the first and second food passageways each define a food flow path and are configured and adapted such that food product travels along the food flow paths approximately the same distance from the inlet passageway to the food product outlet but also such that food product travels more slowly along the food flow path of the second food passageway than along the food flow path of the first food passageway.

3. An extruder in accordance with claim 2 wherein the extruder comprises a removable restrictor that is configured to limit how quickly food will flow from the inlet passageway to the die outlet via the second food passageway.

4. An extruder in accordance with claim 1 wherein the second food passageway in comprised of multiple sub-passageways and the first food passageway is cylindrical and as centrally positioned between the multiple sub-passageways of the second food passageway.

5. An extruder in accordance with claim 4 wherein the extruder comprises a removable restrictor that is configured to limit how quickly food will flow from the inlet passageway to the die outlet via the second food passageway, the restrictor is a washer having a central circular opening, and the circular opening has a greater diameter than the cylindrical first food passageway and is aligned with the first food passageway.

6. An extruder in accordance with claim 1 wherein the extruder comprises a die plate unit and an adapter unit, the die plate unit comprises the die outlet, and the adaptor unit structurally connects the die plate unit to the auger unit and comprises the first and second food passageways.

7. An adaptor unit for mixing food product being extruded from a food extruder, the adaptor unit being configured and adapted to operatively attach to an auger unit of an extruder to a die plate unit of the extruder that comprises a die outlet for expelling food product as an extrudate, the adaptor unit comprising at least first and second food passageways that are each configured and adapted to operatively and in parallel connect a food product outlet of the auger unit to the die outlet of the die plate unit, the first and second food product passageways being configured such that food product passing into the adaptor unit from the food product outlet of the auger unit will travel through the adapter unit to the food product inlet of the die plate unit more quickly than food product passing through the second food passageway will travel from the food product outlet of the auger unit to the food product inlet of the die plate.

8. An adaptor unit in accordance with claim 7 wherein the adaptor unit comprises a removable restrictor that is configured to limit how quickly food will flow from the auger unit to the die plate unit via the second food passageway.

9. Wherein the adaptor unit is configured to attach indirectly to the auger unit.

10. A method of extruding food product comprising:
forcing an amount of food product into a food product inlet passageway via an extruder screw;
channeling a first portion of the amount of food product from the food product inlet passageway into a first food passageway while simultaneously channeling a second portion of the amount of food product from the food product inlet passageway into a second food passageway by forcing additional food product into the food product inlet passageway, the first food passageway having a downstream outlet that discharges into a third food passageway, the second food passageway having a downstream outlet that discharges into the third food passageway, the first and second food passageways being operatively parallel; and thereafter
forcing additional food product into the first and second food passageways via the extruder screw and in manner causing the first and second portions of the amount of food product to enter the third passageway, the first portion of the amount of food product entering the third food passageway prior to the second portion of the amount of food product.

11. Using the method of claim 10 to form a multi-colored cereal piece.

12. A method of extruding food product comprising:
channeling food product from an auger unit of an extruder to a die outlet of the extruder via at least two operatively parallel food passageways, food product passing through one of the two food passageways taking longer to travel from the auger unit to the die outlet than food product passing through the other of the two food passageways.
